(19) United States
(12) Patent Application Publication
(10) Pub. No.: US 2016/0180874 A1
(43) Pub. Date: Jun. 23, 2016

(54) HARD MAGNETIC ALLOY THIN FILM USED IN HIGH DENSITY PERPENDICULAR MAGNETIC RECORDING MEDIUM

(71) Applicant: Ming Chi University of Technology, New Taipei City (TW)

(72) Inventors: Sheng-Chi CHEN, New Taipei City (TW); Ta-Huang SUN, New Taipei City (TW)

(21) Appl. No.: 14/578,665

(22) Filed: Dec. 22, 2014

(51) Int. Cl. G11B 5/64; G11B 5/851; H01F 1/047

(52) U.S. Cl. CPC G11B 5/647; H01F 1/047; G11B 5/851

(57) ABSTRACT

This invention discloses a hard magnetic alloy thin film used in a high density perpendicular magnetic recording medium. This film incorporates a glass substrate and a ferromagnetic layer formed on the glass substrate. The ferromagnetic layer is deposited onto the substrate using a sputtering deposition and an annealing. After annealing, a single-layered ferromagnetic film with high perpendicular magnetic anisotropy is achieved.

### BACKGROUND OF THE INVENTION

1. Field of the Invention

The present invention relates to a hard magnetic alloy thin film used in a high density perpendicular magnetic recording medium, more particularly to a single-layered ferromagnetic film with high perpendicular magnetic anisotropy.

2. Description of the Prior Art

The conventional hard drive records data in longitudinal recording manner. However, in longitudinal recording medium, the magnetization directions of adjacent bit units are anti-parallel to each other and it is subject to super paramagnetic limit, the recorded data is volatile due to thermal instability as the recording density reaches a threshold. Therefore, the ultra-high recording density cannot be achieved. In perpendicular recording scheme, the magnetization direction of the recording medium is perpendicular to film surface, while the demagnetizing field H_{d} is smaller and the recording layer is thicker. Therefore, the perpendicular recording scheme is recognized to solve the thermal instability problem for recording and can further enhance recording density. Moreover, the magnetization direction of the recording medium is perpendicular to film surface such that the magnetic lines are parallel to each other with reverse direction and magnetic lines will not repel each other, whereby the magnetic lines have higher density to achieve higher recording density.

In Stoner-Wohlfarth model, the following equation should be satisfied to ensure that the magnetization of the magnetic particles will not decay due to thermal agitation, where Kᵤ is magnetocrystalline anisotropy constant, V is the volume of magnetic particle, T is absolute temperature and K_{B} is the Boltzmann constant.

KᵤV/K_{B}T>60

The recording medium in the current hard disc drive is Co-based alloy, which has Kᵤ value of 2×10⁶ erg/cm³ and minimal stable grain size of 10.4 nm. Therefore, this medium will encounter thermal stability issue and cannot be used as ultra-high density recording medium when the size of the magnetic particle reduces to below 10 nm.

L1₀ FePt and CoPt are materials with high Kᵤ of 7×10⁷ erg/cm³ and 5×10⁷ erg/cm³, respectively and the minimal stability particle size can be reduced to 3 and 3.6 nm, respectively. Therefore, they are candidate materials to replace the current Co-based alloy (such as CoCrPt) and become material for next-generation ultra-high density recording medium. However, the L1₀ FePt and CoPt are FCT (face-centered tetragonal) structure with (111) preferred orientation. The FePt and CoPt thin films will tend to become in-plane magnetic anisotropy after annealing and cannot be applied to perpendicular magnetic recording medium. Therefore, L1₀ FePt and CoPt thin films with perpendicular magnetic anisotropy are generally achieved by MgO or CrRu underlayer with proper buffer layer. Nevertheless, multilayer structure will increase cost and inter-diffusion may occur between magnetic layer and underlayer (or buffer layer), thus degrading the overall magnetic property of the magnetic recording thin film. It is desirable to provide an alloy with simple stratified structure and perpendicular magnetic anisotropy to be candidate material for ultra-high density magnetic recording materials.

It is desirable to provide a novel hard magnetic alloy thin film to overcome above-mentioned drawbacks.

### SUMMARY OF THE INVENTION

It is an object of the present invention to disclose a hard magnetic alloy thin film used in a high density perpendicular magnetic recording medium. The hard magnetic alloy thin film has simple stratified structure with only a glass substrate and a ferromagnetic layer. The ferromagnetic layer is directly deposited on the glass substrate in room temperature by High power impulse magnetron sputtering (HIPIMS) process. The thus-deposited ferromagnetic layer is then annealed to provide a single-layered ferromagnetic film with high perpendicular magnetic anisotropy.

Accordingly, the present invention provides a hard magnetic alloy thin film used in a high density perpendicular magnetic recording medium. The hard magnetic alloy thin film comprises a glass substrate; and a ferromagnetic layer formed on the glass substrate. The ferromagnetic layer is formed on the glass substrate by a sputtering process and then annealed to form a single-layered ferromagnetic alloy film with perpendicular magnetic anisotropy. The sputtering process provides peak power density of 1000-3600 W/cm² for target.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows the film structure of the a hard magnetic alloy thin film used in a high density perpendicular magnetic recording medium according to a preferred embodiment of the present invention.

FIGS. 2A and 2B show the hysteresis loop of the single-layered ferromagnetic alloy films of the comparative example and the present invention, respectively, after annealing.

FIG. 3 show the XRD curves for the FePt alloy film of the embodiment of the present invention and the comparative example.

FIGS. 4A-4F show the TEM bright-field cross-sectional view for the FePt alloy film of the embodiment of the present invention (FIG. 4B, FIG. 4D and FIG. 4F) and the comparative example (FIG. 4A, FIG. 4C and FIG. 4E).

FIG. 4G shows the Inverse Fourier Transform result for the FePt alloy film in the square region of FIG. 4F.

FIGS. 5A and 5B show peak voltage and peak current applied to target for the sputtering process forming FePt alloy film in the present invention (FIG. 5B) and the comparative example (FIG. 5A).

FIG. 6 shows the plasma spectroscopy detected by Optical Emission Spectrometer (OES) for the sputtering process of FePt alloy film in the present invention and the comparative example.

FIGS. 7A-7F show the TEM bright-field cross-sectional view for the FePt alloy film of the embodiment of the present invention (FIG. 7B, FIG. 7D and FIG. 7F) and the comparative example (FIG. 7A, FIG. 7C and FIG. 7E) after sputtering.

FIGS. 8A and 8B show the stress measurement for the FePt alloy film of the comparative example and the embodiment of the present invention after sputtering, respectively.

FIG. 9 shows the Grazing Incidence X-ray Diffraction (GIXRD) of the sputtered FePt alloy film formed by HIPIMS system and the DCMS system.

FIGS. 10A and 10B shows the AES analysis result for the sputtered FePt alloy films formed by the DCMS system in the comparative example (FIG. 10A) and the sputtered FePt alloy films formed by the HIPIMS system of the present invention (FIG. 10B), respectively.

### DETAILED DESCRIPTION OF THE INVENTION

The present invention provides a hard magnetic alloy thin film used in a high density perpendicular magnetic recording medium, and the hard magnetic alloy thin film comprises a substrate and a ferromagnetic layer. The substrate is a glass substrate and the ferromagnetic layer is formed on the substrate with high power impulse magnetron sputtering (HIPIMS) process. The ferromagnetic layer is a Fe-based alloy (preferably a FePt alloy) and has thickness of 30 nm. The FePt alloy, after sputtering, is annealed in a tube furnace with 1.0×10⁻⁶ Torr vacuum degree. The annealed single-layered ferromagnetic alloy film has perpendicular magnetic anisotropy with perpendicular coercivity (Hc_{⊥}) larger than 6 kOe. Moreover, the annealed single-layered ferromagnetic alloy film has isolated island structure and has potential usage in ultra-high density perpendicular magnetic recording.

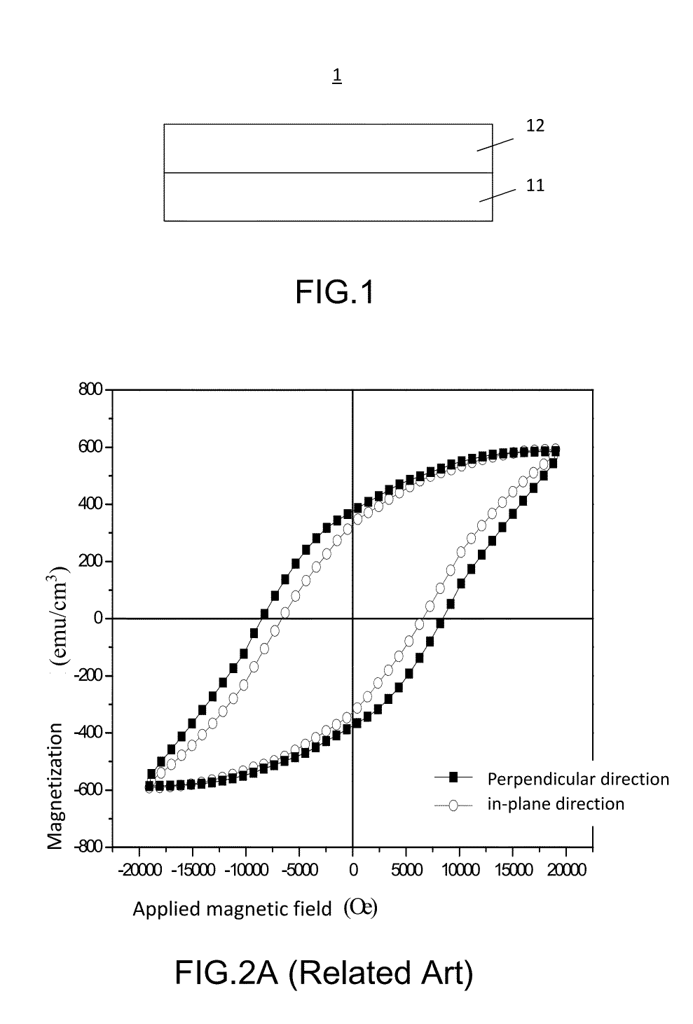

FIG. 1 shows the film structure of the a hard magnetic alloy thin film used in a high density perpendicular magnetic recording medium according to a preferred embodiment of the present invention. The hard magnetic alloy thin film 1 of the present invention comprises a glass substrate 11 and a ferromagnetic layer 12. The ferromagnetic layer 12 is formed on the glass substrate 11 by HIPIMS process. The ferromagnetic layer 12 is a Fe-based alloy and is preferably a FePt alloy. The thickness of the ferromagnetic layer 12 is 30-50 nm and is preferably 30 nm. The Fe concentration in the Fe-based alloy is 40-60 at. % and is preferably Fe₅₀Pt₅₀.

As shown in FIG. 1, the hard magnetic alloy thin film 1 of the present invention comprises a glass substrate 11 and a ferromagnetic layer 12. The FePt ferromagnetic layer 12 has 30 nm thickness and the HIPIMS power is kept to be 300 watt. The peak power density of target is 3538 W/cm². The base pressure is better than 5.0×10⁻⁷ Torr. The argon pressure for sputtering is fixed at 15 mTorr. The rotation speed of substrate is 10 rpm. The sputtered film is placed in a tube furnace with temperature 700° C. and vacuum degree of 1.0×10⁻⁶ Torr for 30 minutes annealing, and then the sputtered film is quenched to room temperature to achieve a L1₀ FePt hard magnetic phase with perpendicular magnetic anisotropy, thus obtaining a magnetic recording alloy film with high perpendicular magnetic anisotropy.

The magnetic property of the FePt alloy film in the present invention can be measured with Vibrating Sample Magnetometer (VSM). The phase structure of the FePt alloy film can be determined by Cu-Kα radiation of XRD. The transverse micro structure of the FePt alloy film can be observed with HR-TEM. The film stress analysis can be obtained by Stoney's equation.

(Embodiment of the Present Invention)

The FePt alloy film formed by HIPIMS system with 30 nm thickness is annealed in high-vacuum tube furnace with annealing temperature of 700° C. for 30 minutes. The base pressure of the tube furnace is below 1.0×10⁻⁶ Torr. The annealed FePt alloy film is quenched by cold water (around 10° C.) to reach room temperature.

(Comparative Example)

The FePt alloy film formed by conventional DCMS system with 30 nm thickness is annealed in high-vacuum tube furnace with annealing temperature of 700° C. for 30 minutes. The base pressure of the tube furnace is below 1.0×10⁻⁶ Torr. The annealed FePt alloy film is quenched by cold water (around 10° C.) to reach room temperature.

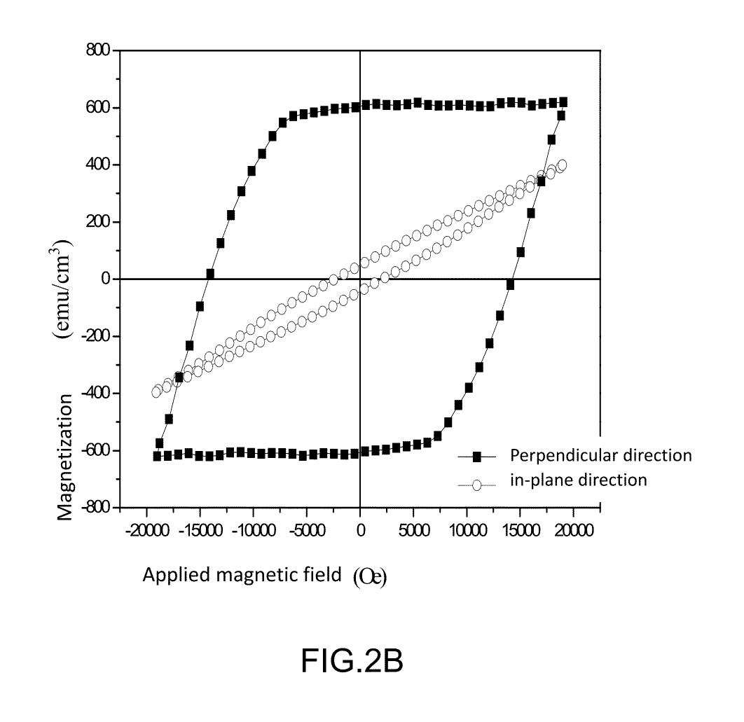

FIGS. 2A and 2B show the hysteresis loop of the single-layered ferromagnetic alloy films of the comparative example and the present invention, respectively, after annealing. As shown in FIG. 2A, the FePt alloy film formed by DCMS system has similar hysteresis curves in in-plane and perpendicular directions. The FePt alloy film has disordered arrangement, and both of the perpendicular coercivity (Hc_{⊥}) and in-plane coercivity (Hc_{//}) are around 8.0 kOe. In comparison with the DCMS-formed FePt alloy film, the FePt alloy film formed by HIPIMS system has larger perpendicular hysteresis loop and shows excellent perpendicular magnetic anisotropy, as shown in FIG. 2B. Therefore, the HIPIMS process can enhance the perpendicular magnetic anisotropy and perpendicular coercivity (Hc_{⊥}) for FePt alloy film. Moreover, in the hysteresis loop of FePt alloy film shown in FIG. 2B, the Hc_{⊥} is 14 kOe, the perpendicular squareness (S_{⊥}), define by the ratio between remanence magnetization and saturation magnetization (Mr/Ms) is larger than 0.9, the saturation magnetization is 620 emu/cm³.

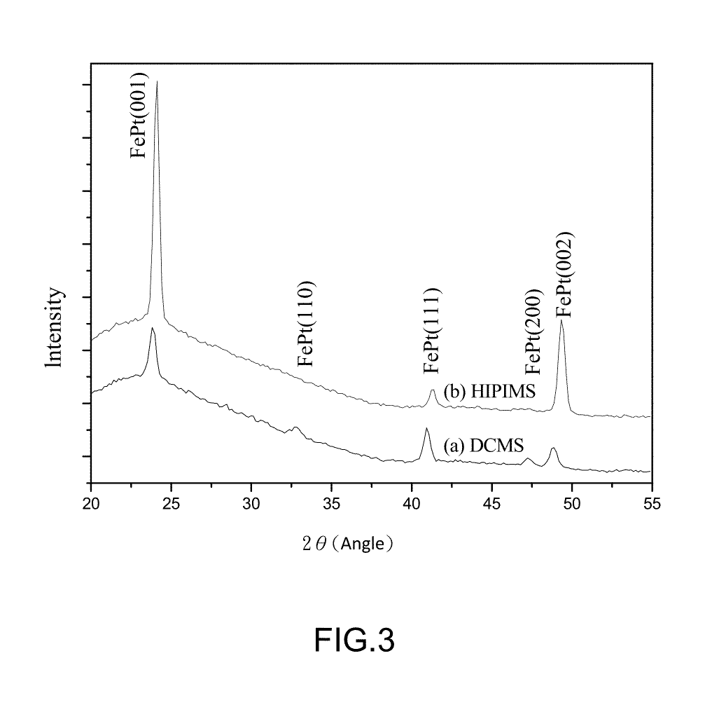

FIG. 3 show the XRD curves for the FePt alloy film of the embodiment of the present invention and the comparative example. As can be seen from the drawing, the FePt alloy film formed by DCMS system (the comparative example) has diffraction peaks (001)_{FePt}, (110)_{FePt}, (111)_{FePt}, (200)_{FePt} and (002)_{FePt}. It means that the FePt alloy film formed by DCMS system has random orientation. On the contrary, the FePt alloy film formed by HIPIMS system (the present invention) has excellent orientation preference. It means that the HIPIMS system can enhance the [001] preferred orientation for FePt alloy film.

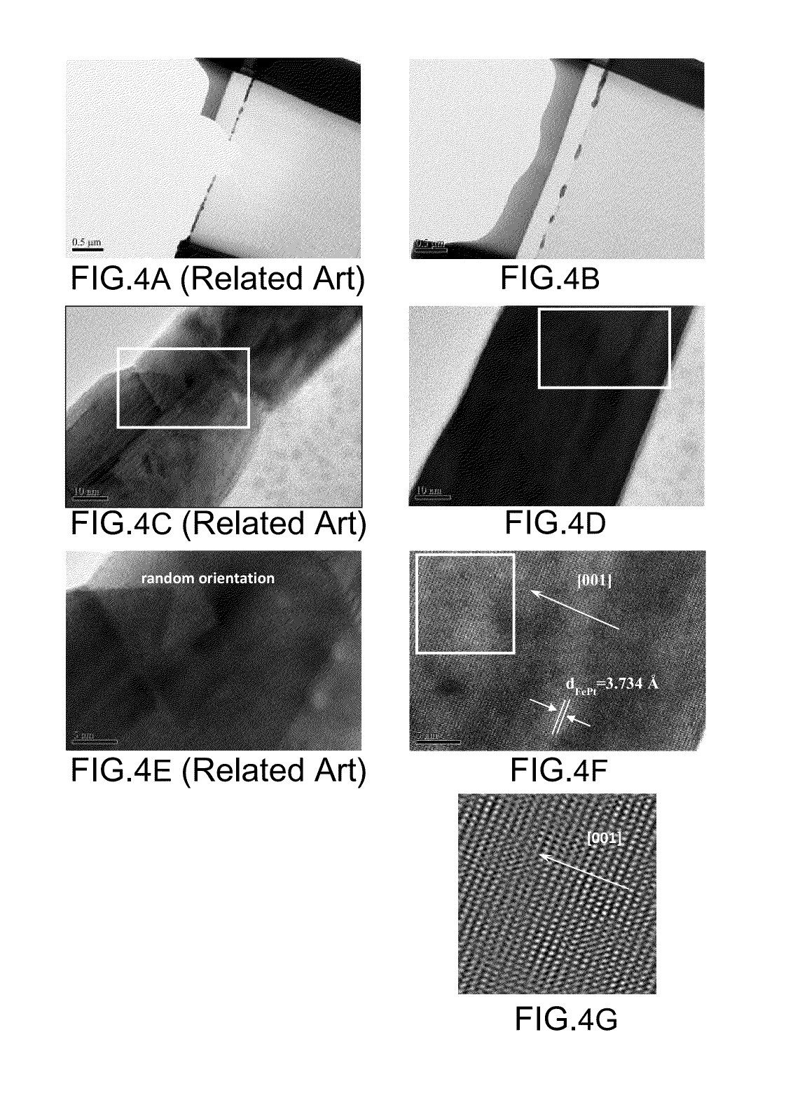

FIGS. 4A-4F show the TEM bright-field cross-sectional view for the FePt alloy film of the embodiment of the present invention and the comparative example. In low-magnification view, the FePt alloy film formed by HIPIMS system (FIG. 4B) has more isolated island-shaped FePt film after 700° C. annealing, in comparison with the FePt alloy film formed by DCMS system (FIG. 4A). It should be noted that small amount of FePt particles will sink into the glass substrate after high-temperature annealing. The strain point of Corning 1737 glass substrate is 666° C. The glass substrate become softened and the viscosity drops below 10¹⁴ poises when the annealing temperature is higher than the strain point, this causes part of the FePt particles sinking into the glass substrate, as shown in FIG. 4B. As shown in FIGS. 4C and 4D, as the magnification becomes 300K, the film thickness of the FePt alloy film made by DCMS and HIPIMS system and after 700° C. annealing is not uniform. As shown in FIG. 4F, with the magnification of 800K (HR-TEM), the FePt alloy film formed by HIPIMS system has d spacing (separation between parallel films) of 3.734 Å, which is similar to the c-axis lattice constant (3.735 Å) of L1₀ FePt. It means that the easy axis [001] of magnetization of FePt is perpendicular to the film surface such that the FePt alloy film formed by HIPIMS system has excellent perpendicular magnetic anisotropy. FIG. 4G shows the Inverse Fourier Transform result for a portion of FePt alloy film (shown in the square region of FIG. 4F), it shows that the FePt alloy film has ordered period for atoms. FIG. 4E shows the 800 k (HR-TEM) image of FePt alloy film formed by DCMS system with different crystal facets. The FePt alloy film formed by DCMS system is shown to have more disordered structure with random orientation.

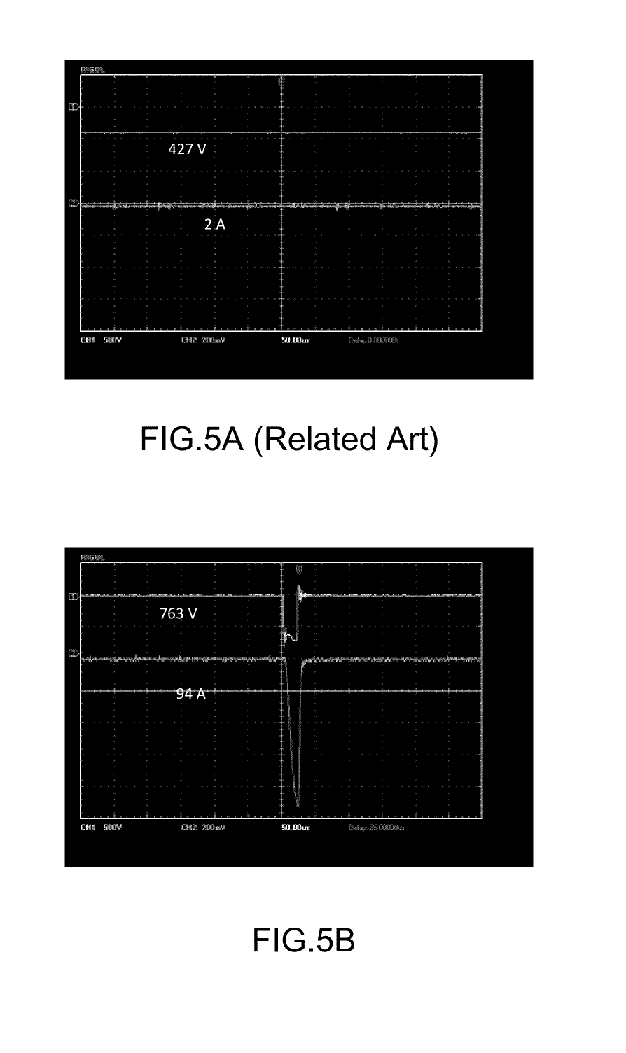

FIGS. 5A and 5B show peak voltage and peak current applied to target for the sputtering process forming FePt alloy film in the present invention and the comparative example. As shown in FIG. 5A, the waveform of voltage and current in DCMS system is relatively continuous (no peak), while the target voltage, the target current and the power density are 427 V, 2 A and 42 W/cm², respectively. In comparison with DCMS system, the target voltage and the target current in HIPIMS system are discontinuous such that the peak power density can be 3538 W/cm², 84 times of the power density in DCMS system.

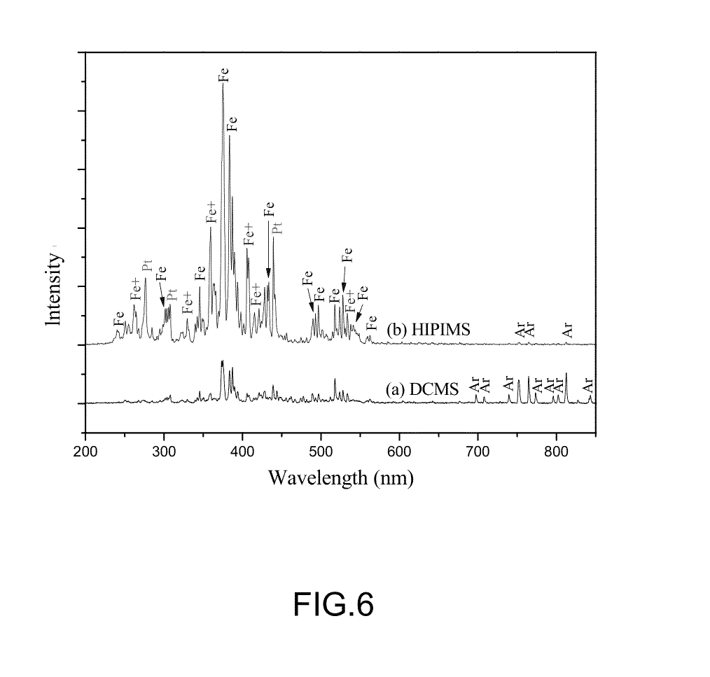

FIG. 6 shows the plasma spectroscopy detected by Optical Emission Spectrometer (OES) for the sputtering process of FePt alloy film in the present invention and the comparative example. As shown in the curve (a), the FePt alloy film formed by DCMS system has weak plasma spectroscopy and only peaks of neutral atoms. As shown in the curve (b), the FePt alloy film formed by HIPIMS system has apparent peaks in high energy region (shorter wavelength region of 200-400 nm) and peaks for Fe ion. It means that the HIPIMS system can enhance the ionization of sputtered atoms and increase the energy of the sputtered atoms.

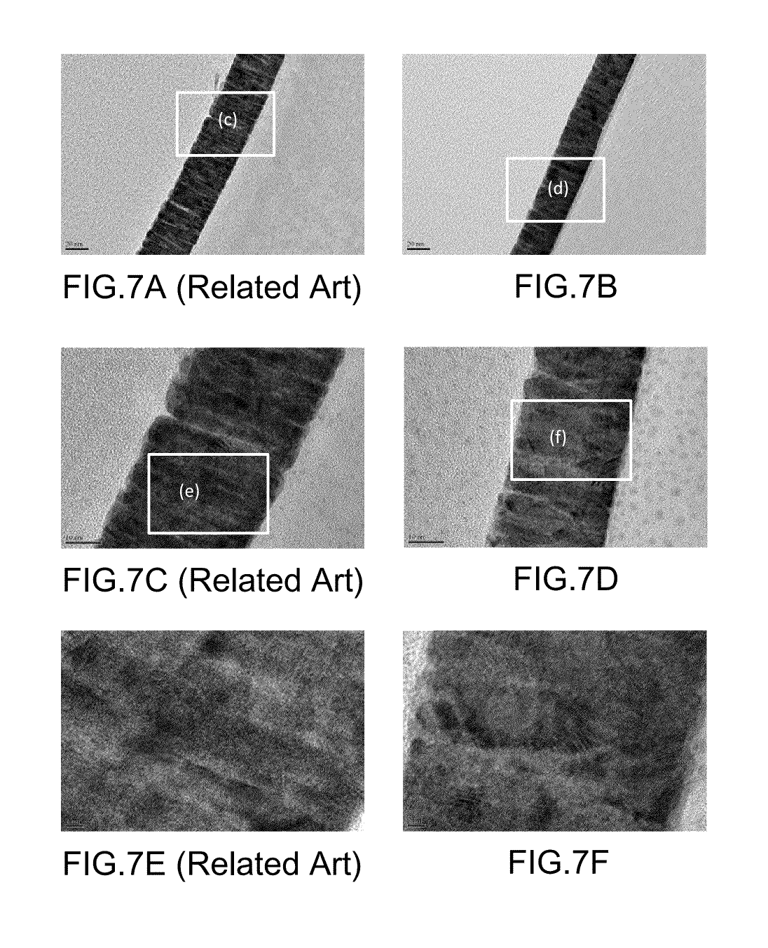

FIGS. 7A-7F show the TEM bright-field cross-sectional view for the as-deposited FePt alloy film of the embodiment of the present invention and the comparative example after sputtering. Under 100K magnification, the as-deposited FePt alloy films formed by DCMS system (FIG. 7A) and HIPIMS system (FIG. 7B) are columnar structures. However, HIPIMS-formed FePt alloy film has compact structure and smooth surface in comparison with DCMS-formed FePt alloy film. The cause may be that HIPIMS system has higher sputtered atom energy (higher peak power density), this provide effect similar to ion bombardment, thus compact the thin firm. The FePt alloy film formed by HIPIMS system has more compact structure and more smooth surface, as shown in FIGS. 7C and 7D. As can be seen from FIGS. 7E and 7F, the FePt alloy film formed by HIPIMS system has better crystallinity. It may be caused by higher sputtered atom energy and higher plasma temperature of HIPIMS system, longer deposition time (deposition rate is slower), thus achieving better crystallinity.

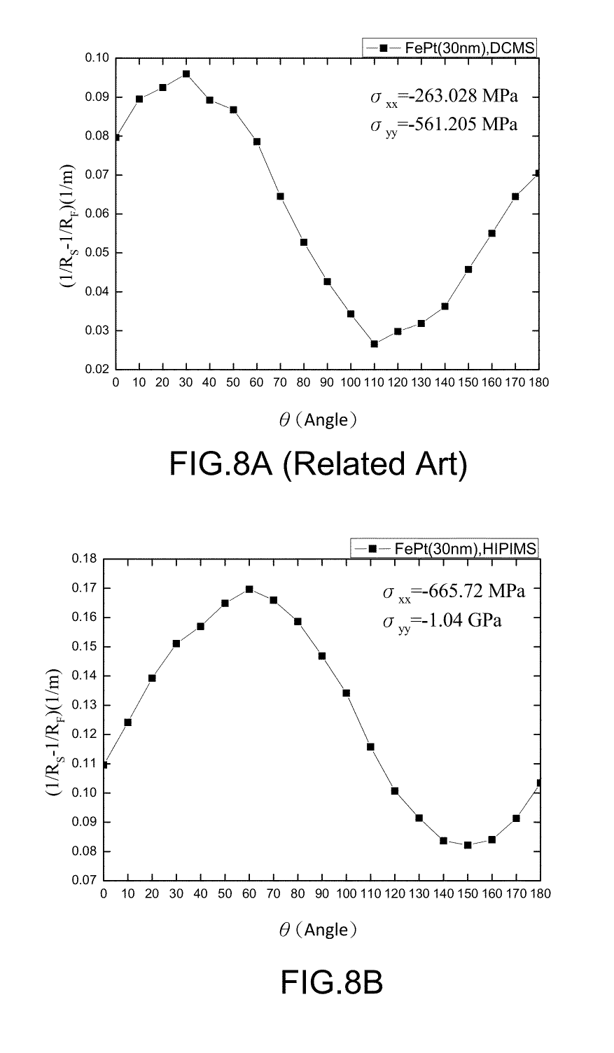

FIGS. 8A and 8B show the stress measurement for the as-deposited FePt alloy film of the comparative example and the embodiment of the present invention after sputtering, respectively. In FIG. 8, ordinate Rₛ indicates the warp of the substrate, ordinate R_{F} indicates the warp of the substrate after sputtering, the parameters σₓₓ and σ_{yy} indicate the stresses along x direction and y direction, respectively. From calculation based on the warp variations in FIG. 8, both of the sputtered FePt alloy films formed by DCMS and HIPIMS systems show compressive stress. Moreover, the parameters σₓₓ and σ_{yy} of the FePt alloy films formed by DCMS system are −263.028 and −561.205 MPa, respectively, while the parameters σₓₓ and σ_{yy} of the FePt alloy films formed by HIPIMS system are −665.72 MPa [symbol] -1.04 GPa, respectively, much larger than the counterparts of DCMS-formed one. The FePt alloy film formed by HIPIMS system has higher compressive inner stress due to the deposition of atoms with higher energy and ion bombardment. For thin film with smaller inner stress, the grain will grow toward the direction with lower surface energy or interface energy, during annealing namely, the direction for closed packing For thin film with larger inner stress, the grain will grow toward the direction for lowering the elastic strain energy, which may differ with the direction for closed packing If the coefficient of thermal expansion of the substrate is larger than that of the FePt alloy film, the FePt alloy film will be subject to in-plane tensile stress during thermal treatment. The a-axis of the FePt alloy lattice will expand and reduce the c-axis such that the plane (001) grows along the film surface to achieve [001] direction preference.

In this embodiment, the compressive inner stress of the sputtered FePt alloy film formed by HIPIMS system is twice of that of sputtered FePt alloy film formed by DCMS system. Considerable strain-induced grain growth occurs in FePt alloy film formed by HIPIMS system when the sputtered FePt alloy film is annealed at a temperature of 700° C. The glass substrate will also expands significantly when the annealing temperature is higher than the strain point (666° C.) of Corning 1737 glass substrate. The high stress exerts great in-plane tensile stress on the thin film while inducing the FePt grain growth. Therefore, the plane (001) grows along the film surface to achieve [001] direction preference. The FePt alloy film formed by HIPIMS system has excellent perpendicular magnetic anisotropy.

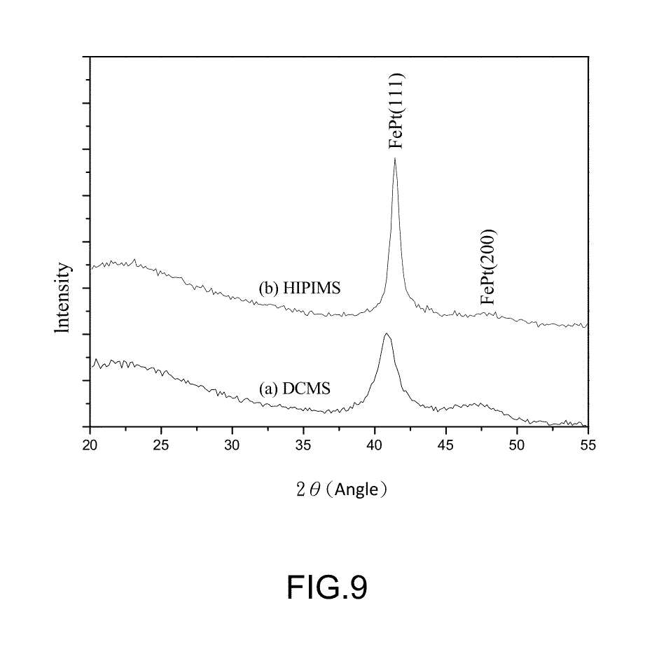

FIG. 9 shows the Grazing Incidence X-ray Diffraction (GIXRD) of the as-deposited FePt alloy film formed by HIPIMS system and the DCMS system. The as-deposited FePt alloy films formed by HIPIMS system (curve b) and the DCMS (curve a) both show [111] preferred orientation. However, the (111)_{FePt} diffraction peak of the as-deposited FePt alloy films formed by HIPIMS system is larger than that of the sputtered FePt alloy films formed by DCMS system, this may be caused by higher sputtered atom energy and higher plasma temperature of the HIPIMS system, which achieves better crystallinity for sputtered FePt alloy films. Moreover, the (111)_{FePt} diffraction peak of the as-deposited FePt alloy films formed by HIPIMS system is shifted toward higher angle region in comparison with that formed by DCMS system. From Bragg's law, the lattice constant of the sputtered FePt alloy films formed by HIPIMS system should be smaller than that formed by DCMS system, and this can be attributed to larger compressive stress in the sputtered FePt alloy films formed by HIPIMS system.

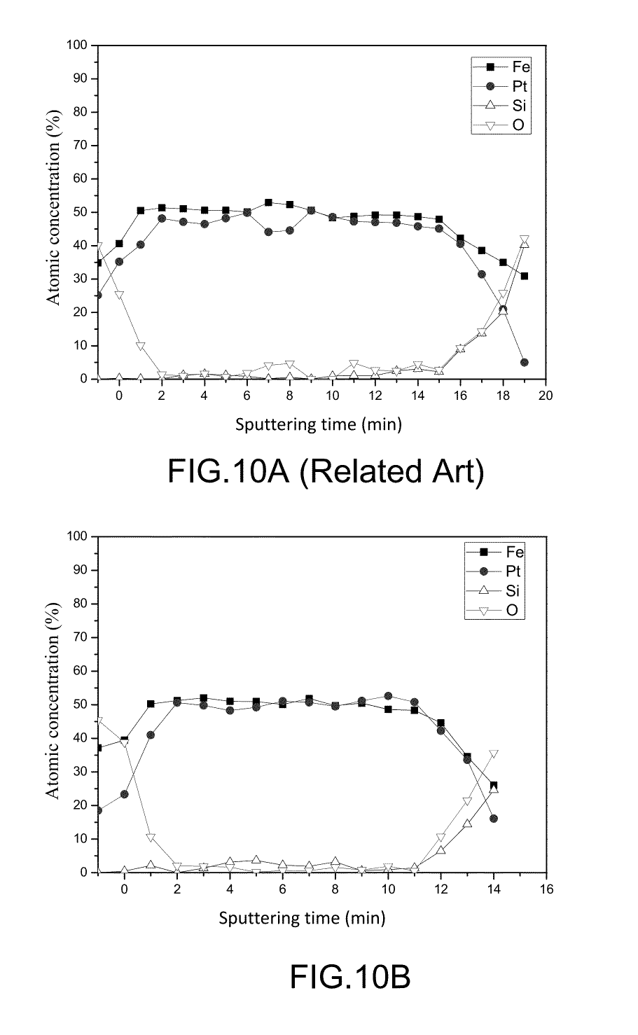

FIGS. 10A and 10B shows the AES analysis result for the as-deposited FePt alloy films formed by the DCMS system in the comparative example (FIG. 10A) and the as-deposited FePt alloy films formed by the HIPIMS system of the present invention (FIG. 10B), respectively. As can be seen from the figures, the Fe and Pt concentrations do not show clear distinction along depth direction for the as-deposited FePt alloy films formed by the DCMS system and by the HIPIMS system of the present invention. The Fe and Pt concentrations are close to 50 at. %. It means that the (001) texture of the FePt alloy films formed by HIPIMS system is not resulted from concentration variation.

The interface tensions of the glass substrate exerting to the FePt films are similar for the FePt films formed by DCMS and HIPIMS systems. However, the as-deposited FePt alloy films formed by HIPIMS system have large compressive stress, which can enhance the driving force of the thin film during annealing. Therefore, the in-plane tensile stress of the sputtered FePt alloy films formed by HIPIMS system is much larger than that formed by DCMS system, thus achieving excellent perpendicular magnetic anisotropy.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

1. A hard magnetic alloy thin film used in a high density perpendicular magnetic recording medium, the hard magnetic alloy thin film comprising:
a glass substrate; and
a ferromagnetic layer formed on the glass substrate,
wherein the ferromagnetic layer is formed on the glass substrate by a sputtering process and then annealed to form a single-layered ferromagnetic alloy film with perpendicular magnetic anisotropy,
wherein the sputtering process provides peak power density of 1000-3600 W/cm² for a target, the sputtering process is a high power impulse magnetron sputtering (HIPIMS) process, and the ferromagnetic layer has peaks of Fe ion in a high energy region of 200 nm-400 nm with a plasma spectroscope determining by optical emission spectrometer.

2. (canceled)

3. The hard magnetic alloy thin film in claim 1, wherein the ferromagnetic layer has thickness of 30-50 nm.

4. The hard magnetic alloy thin film in claim 1, wherein the ferromagnetic layer is annealed at a temperature higher than 550° C. and with a duration of 30 minutes.

5. The hard magnetic alloy thin film in claim 1, wherein the ferromagnetic layer is annealed at a vacuum degree of 1.0×10⁻⁶ Torr.

6. The hard magnetic alloy thin film in claim 1, wherein the ferromagnetic layer is Fe-based alloy.

7. The hard magnetic alloy thin film in claim 6, wherein the Fe-based alloy is FePt alloy.

8. The hard magnetic alloy thin film in claim 1, wherein a perpendicular coercivity of the single-layered ferromagnetic alloy film is larger than 6 kOe.

9. The hard magnetic alloy thin film in claim 1, wherein a saturation magnetization of the single-layered ferromagnetic alloy film is larger than 300 emu/cm³.

10. The hard magnetic alloy thin film in claim 1, wherein a perpendicular squareness of the single-layered ferromagnetic alloy film is larger than 0.9.

11. The hard magnetic alloy thin film in claim 1, wherein the single-layered ferromagnetic alloy film has discontinuous isolated-island-shaped microstructure.
